(19) United States
(12) Patent Application Publication
(10) Pub. No.: US 2015/0271217 A1
(43) Pub. Date: Sep. 24, 2015

(54) INFORMATION TERMINAL APPARATUS USED IN CONFERENCE AND CONFERENCE SYSTEM

(71) Applicant: TOSHIBA TEC KABUSHIKI KAISHA, Tokyo (JP)

(72) Inventor: Takahisa Hirano, Shizuoka-ken (JP)

(73) Assignee: TOSHIBA TEC KABUSHIKI KAISHA, Tokyo (JP)

(21) Appl. No.: 14/219,382

(22) Filed: Mar. 19, 2014

(51) Int. Cl. H04L 29/06; H04L 29/08

(52) U.S. Cl. CPC H04L 65/403; H04L 67/10

(57) ABSTRACT

In accordance with one embodiment, an information terminal apparatus comprises a storage section, a network interface and a control section. The storage section stores data to be used in a conference. The network interface carries out data communication during the conference. The control section erases, if the communication through the network interface is interrupted, the data stored in the storage section to be used in the conference.

### FIELD

Embodiments described herein relate to a technology for deleting conference data.

### BACKGROUND

In recent years, an information sharing system has been developed which is capable of achieving a multi-person conference, a meeting, or a presentation. In a case of using such a system, every conference participant attends the conference with his own portable information terminal apparatus such as a notebook computer, a tablet PC (Personal Computer), a smart phone and the like.

There exists a case where information with high confidentiality is discussed in a conference or presentation. In this case, it is necessary to prevent various data such as the used material from being taken out.

### BRIEF DESCRIPTION OF THE DRAWINGS

FIG. 1 is a diagram illustrating an example of the constitution of a conference system according to an embodiment;

FIG. 2 is a block diagram illustrating an example of the constitution of a tablet PC;

FIG. 3 is a diagram illustrating an example of display according to the embodiment;

FIG. 4 is a flowchart illustrating an example of operations of the tablet PC;

FIG. 5 is a diagram illustrating an example of the data constitution relating to a holding authority of a file; and

FIG. 6 is a flowchart illustrating an example of operations of the tablet PC taking the holding authority of the file into consideration.

### DETAIL DESCRIPTION

In accordance with one embodiment, an information terminal apparatus comprises a storage section, a network interface and a control section. The storage section stores data to be used in a conference. The network interface carries out data communication during the conference. The control section erases, if the communication through the network interface is interrupted, the data stored in the storage section to be used in the conference.

Further, in accordance with one embodiment, a conference system comprises a server apparatus, an access point and an information terminal apparatus. The access point has a leaky coaxial cable. The information terminal apparatus carries out data communication with the server apparatus through the access point, and erases data stored in its own storage section to be used in the conference if the communication is interrupted.

A system using which a plurality of persons can share a same screen with their own information terminal apparatus such as a smart phone or a tablet PC is described in the embodiment. In the embodiment, when the conference is ended or if the network is disconnected, the image of the material data which has been displayed is erased from the information terminal apparatus. Further, in the embodiment, the data stored in the storage section is also erased. The erasing of the data may also be time limit type.

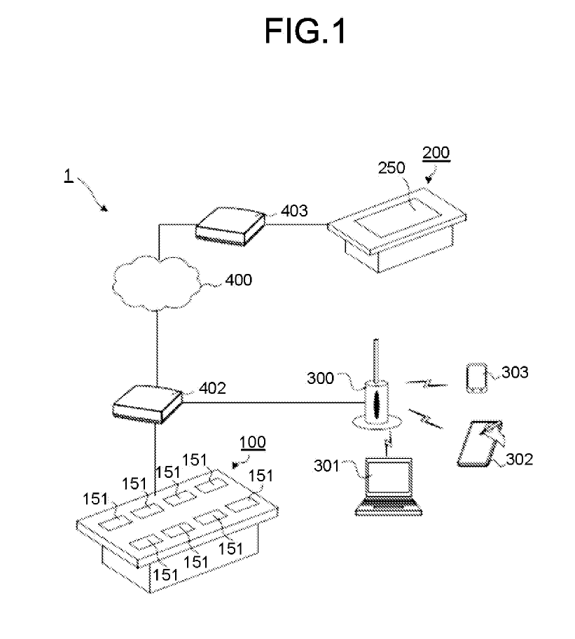

FIG. 1 is a schematic diagram illustrating the constitution of the system according to the embodiment. A conference system 1 according to the embodiment includes two desktop type information processing apparatuses 100 and 200. As one form, the desktop type information processing apparatus 100 is arranged in the conference room of the head office and the desktop type information processing apparatus 200 is arranged in the conference room of branch office. The desktop type information processing apparatuses 100 and 200 carry out data transmission/reception with each other through a wide area network 400 and communication devices 402 and 403. The communication devices 402 and 403 are, for example, a router or a switching hub.

The desktop type information processing apparatus 100 has a plurality of touch panel displays 151. The touch panel displays 151 can display different content, respectively. The touch panel displays 151 have display surfaces on the top plate of the desktop type information processing apparatus 100. A computer system consisting of a processor, a storage section and the like is included inside the desktop type information processing apparatus 100.

The desktop type information processing apparatus 200 has a flat top plate surface on which a large-sized touch panel display 250 is arranged. A computer system consisting of a processor, a storage section and the like is also included inside the desktop type information processing apparatus 200.

The conference system 1 further includes an access point 300. The access point 300 is connected with the communication device 402 and constitutes a portable information terminal apparatus and a wireless LAN (Local Area Network). A notebook PC 301, a tablet PC 302 and a smart phone 303 are exemplified as the portable information terminal apparatus in the present embodiment. The notebook PC 301, the tablet PC 302 and the smart phone 303 can carry out data transmission/reception with the desktop type information processing apparatuses 100 and 200 through the access point 300 and the communication device 402.

The access point 300 is described below. The access point 300 has a LCX (Leaky Coaxial Cable), and can restrict the electric wave reaching range due to the using of the LCX technology compared with a conventional wireless LAN. In the present embodiment, the access point 300 creates an area for carrying out encryption communication within a range having a radius of about 4 m, and interrupts the communication beyond the range. The communication range and the number of the connection terminals can be set by a user. The illegal intrusion and the interception from outside become difficult by narrowing the electric wave reaching range, thus, a high security can be guaranteed. The access point 300 may be an existing conventional device.

In the conference system 1, the desktop type information processing apparatus 100 serves as the server apparatus, and the other desktop type information processing apparatus 200, the notebook PC 301, the tablet PC 302 and the smart phone 303 serve as a client.

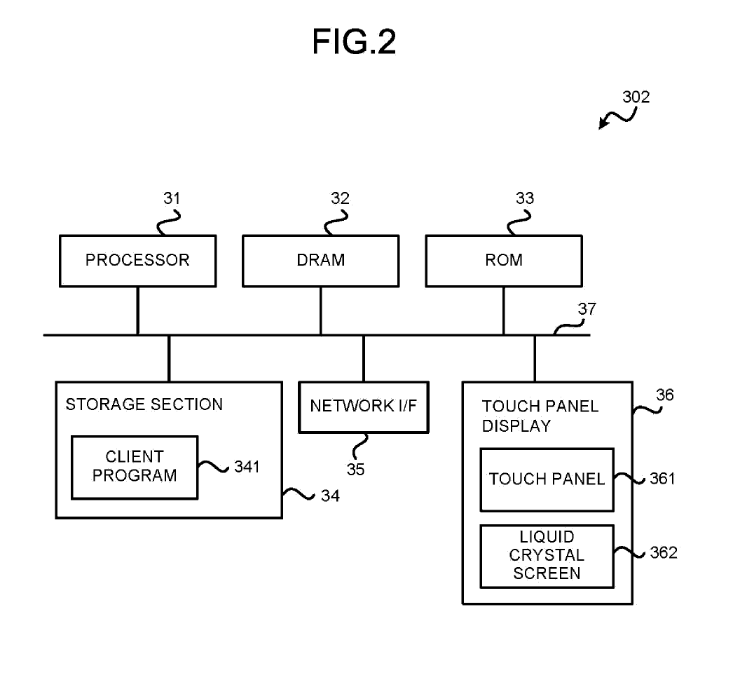

FIG. 2 is a block diagram illustrating an example of the internal constitution of the portable information terminal apparatus, and as an example, the constitution of the tablet PC 302 is illustrated.

The tablet PC 302, which is structurally identical to the existing tablet PC, includes a processor 31, a DRAM (Dynamic Random Access Memory) 32, a ROM (Read Only Memory) 33, a storage section 34, a network I/F 35 (I/F: Interface) and a touch panel display 36 which carry out data transmission/reception and signal input/output through a system bus line 37.

The processor 31 is a CPU (Central Processing Unit) in the present embodiment. The processor 31 expands a program pre-stored in the storage section 34 or the ROM 33 in the DRAM 32, and executes the program to uniformly control each unit in the apparatus. The DRAM 32 is a volatile primary storage device and the ROM 33 is a nonvolatile storage device for storing a system program and the like. The storage section 34 is a nonvolatile auxiliary storage device for storing the data of a user using the tablet PC 302 and the program used by a user. The storage section 34 may be detachably connected with the tablet PC 302. In the present embodiment, the storage section 34 stores a client program 341 in advance, and realizes the following functions according to a code command of the client program 341.

The network I/F 35 carries out data transmission/reception with an external device through the access point 300. In the present embodiment, the network I/F 35 carries out data communication with the desktop type information processing apparatus 100 serving as the server apparatus. The communication module carries out wireless communication using the LCX technology, however, the present invention is not limited to this, and wired communication may also be carried out. In addition, the network I/F 35 further includes a terminal based on an USB (USB: Universal Serial Bus) standard, and can carry out data transmission/reception through an USB connection with another device. The network I/F 35 may also include a mechanism connected with a wide area line network.

The touch panel display 36 includes a touch panel 361 and a liquid crystal screen 362. The liquid crystal screen 362 is a flat type liquid crystal screen, and the display surface thereof is arranged on the plane of the tablet PC 302. The touch panel 361 is laminated and arranged on the display surface of the liquid crystal screen 362 to detect the touching of a fingertip of a user or a nib, and outputs the coordinate information of the detected position to the processor 31 and the like.

The constitution of the smart phone 303 is the same as that of the tablet PC 302 described above. The notebook PC 301 consists of the liquid crystal screen 362 and an input device such as a keyboard, a mouse and the like, instead of the touch panel 361. The constitution of the notebook PC 301, except the foregoing constitution, is the same as that of the tablet PC 302 described above.

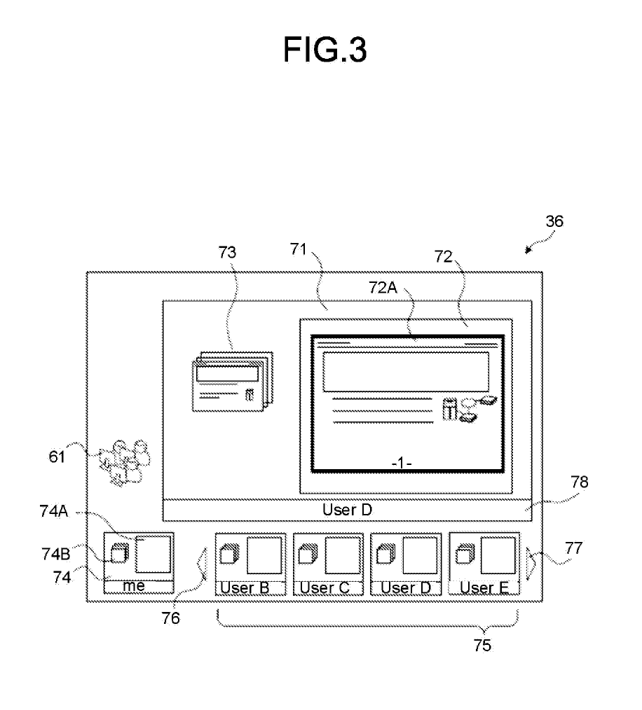

Next, an example of display on the tablet PC 302 is shown in FIG. 3. The image of each icon and the layout of each display area in the example are defined in advance. The desktop type information processing apparatuses 100 and 200, the notebook PC 301 and the smart phone 303 display the same content. Herein, it is exemplified that the tablet PC 302 is held and brought to the conference by a user A serving as a conference participant.

In the display area of the touch panel display 36, there is a presentation area 71 at the upper area, and a sharing icon 61 beside the presentation area 71. In the area below the presentation area 71, there is an area 74 for displaying a thumbnail of the material file prepared by the user A himself. The area 74 is referred to as an own area 74.

Further, in the area below the presentation area 71, there is a list area 75 for displaying thumbnails of the material files prepared by other conference participants. The user operates (touches) arrow icons 76 and 77 to enable the list area 75 to scroll horizontally so as to display the thumbnail images which cannot be completely displayed on one screen.

The internal layout of the presentation area 71 is described below. The area 72 is displaying a material file 72A which is being described by a current presenter, and an area 73 positioned next to the area 72 displays, in an overlaid manner, the thumbnails of other material files prepared by the current presenter. Further, in an area 78 at the lower portion of the presentation area 71, the name of the user who is making a presentation is displayed. In the example, a user D is making a presentation, and the material files prepared by the user D are displayed in the presentation area 71.

The own area 74 has the same layout constitution as that of the presentation area 71. An opened material file of the user A is displayed in the area 74A, and other material files prepared by the user A are displayed in the area 74B. The thumbnail images of other users in the list area 75 have the same layout constitution respectively.

If touching the own area 74, moving and dropping the material file to the thumbnail image of other user in the list area 75 (hereinafter, this operation is referred to as ‘release’), the user A can distribute the prepared material file to the work area (for example, dedicated folder and the like) of the corresponding user. Further, if the user A touches the own area 74 and releases it in the sharing icon 61, the material file prepared by the user A is distributed to all the participants.

In addition, the user A can display the material file prepared by himself in the area 71 by touching the own area 74 and releasing it in the area 71. That is, when making a presentation, the user A touches the own area 74 and releases it in the area 71. In this way, the material file prepared by the user A is largely displayed. In addition, through such an operation, the desktop type information processing apparatuses 100 and 200, the notebook PC 301 and the smart phone 303 display the material file of the user A in the area 71 as well.

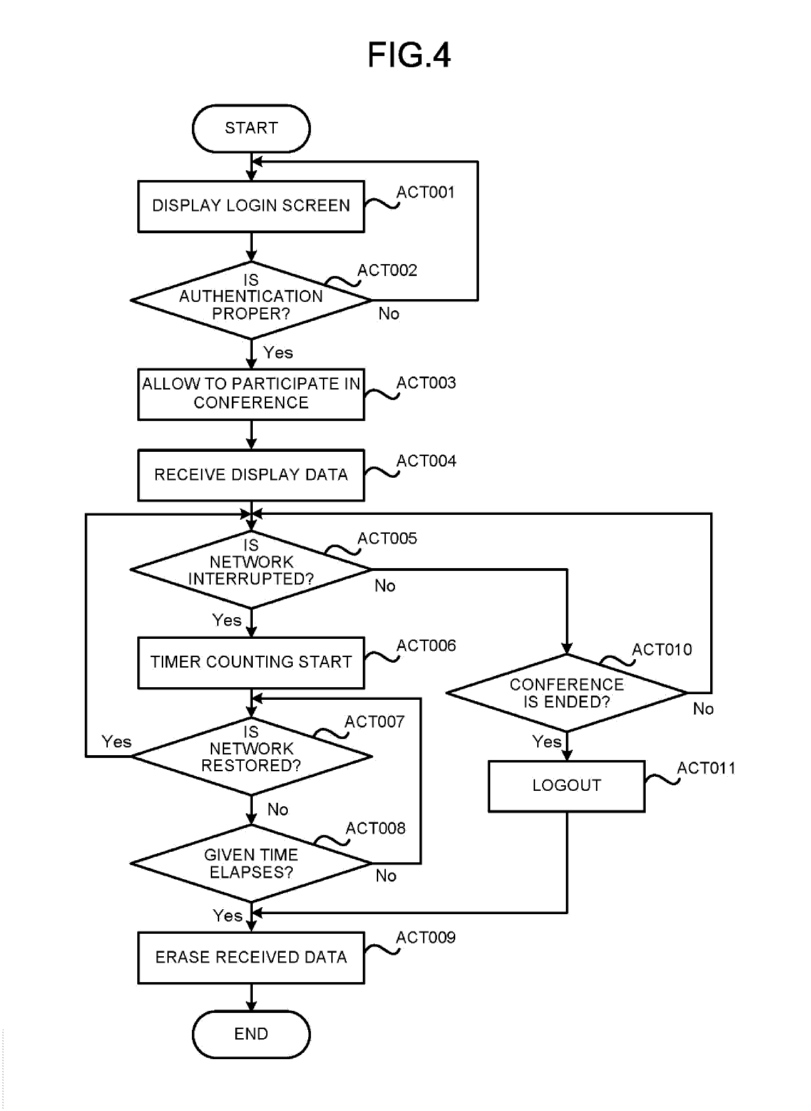

The tablet PC 302 displays the material file of each participant as stated above. At the time of the display, the tablet PC 302 stores the material file in the DRAM 32 or the storage section 34 temporarily, and then displays it on the touch panel display 36. In a case of material with high confidentiality, if a user takes the tablet PC 302 out of the conference room with the material file stored in the DRAM 32 or the storage section 34, there may be a possibility that the confidential item is divulged. In the present embodiment, there is a function of preventing the information from being divulged. This function is described with reference to the flowchart shown in FIG. 4. The conference system 1 consists of a client server, and the desktop type information processing apparatus 100 provides a server function and the other devices including the tablet PC 302 serve as clients.

The operations of the tablet PC 302 are described in the following flowchart, and the same operations are carried out in the notebook PC 301 and the smart phone 303. In addition, each operation is carried out by the processor 31 in the tablet PC 302 according to a code command of the client program 341.

When the client program 341 is started, the processor 31 controls the touch panel display 36 to display a login screen (ACT 001).

The processor 31 determines whether or not the login authentication is proper (ACT 002). The processor 31 sends, via the network I/F 35, the login information (user identification information, pass word and the like) input through the touch panel display 36 to the desktop type information processing apparatus 100 or an authentication server arranged outside the conference system 1, and receives an authentication result. The processor 31 carries out the determination in ACT 002 based on the authentication result. If the authentication is improper (NO in ACT 002), the flow returns to ACT 001, and the touch panel display 36 displays a login screen again (ACT 001).

If the authentication is proper (YES in ACT 002), the processor 31 sends the data relating to the user who passes the authentication to the desktop type information processing apparatus 100. In this way, the user is allowed to participate in the conference (ACT 003).

The processor 31 receives the material file for display and the layout data from the desktop type information processing apparatus 100 (ACT 004). Then, the processor 31 stores the material file data for display and the layout data in either of the storage section 34 or the DRAM 32, or in both of them. Further, the processor 31 sets the display area and the like according to the layout data, and displays the material file data on the touch panel display 36. One example of display is shown in FIG. 3.

The processor 31 constantly monitors the connection state of the network I/F 35 according to the code command of the client program 341. If it is detected that the network is interrupted (YES in ACT 005), the processor 31 starts a timer for determining whether or not a given time elapses (ACT 006). In this example, the given time is set to one minute, however, it is not limited to this.

The processor 31 determines whether or not the network is restored (ACT 007), and then determines whether or not the given time elapses based on the counting of the timer (ACT 008). If the network is restored in the given time (NO in ACT 008 and YES in ACT 007), the flow returns to ACT 005. On the other hand, if the network is not restored in the given time (NO in ACT 007 and YES in ACT 008), the processor 31 erases the data received in ACT 004 (ACT 009). In ACT 009, at least the display images of the material file data are erased from the touch panel display 36, and the material file data stored in the DRAM 32 or the storage section 34 is erased, and moreover, the layout data may also be erased. The deleting is the following processing.

1. The processor 31 rewrites the bit value of each area of the DRAM 32 in which the material file is stored such that the value is different from the data of the material file. For example, the processor 31 sets the bits of each area to a random value, or sets all bits to ‘0’ or ‘1’.

2. The processor 31 controls the touch panel display 36 so as not to display (erase) the object of the material data. The processor 31 similarly rewrites the bits of the buffer area in the DRAM 32 for display. The rewriting method is the same as that recorded in the aforementioned 1.

3. The processor 31 rewrites the bit value of each area of the storage section 34 in which the material file is stored such that the value is different from the data of the material file. The rewriting method is the same as that recorded in the aforementioned 1.

4. Release the storage area guaranteed for storing the material file in the DRAM 32 and the storage area of the buffer for display.

5. Issue a command to delete the material file stored in the storage section 34.

6. End the client program 341.

In addition, in a case where the architecture of the touch panel PC 302 is a standard of releasing the memory in the process of the program ending processing, the operation in the aforementioned 4 can be omitted. Further, in a case where the storage section 34 is a hard disk drive, the processing in the aforementioned 3 is executed for a plurality of times so as to make sure that the data is erased completely. On the other hand, if the storage section 34 is a flash memory, it cannot be guaranteed that a same block is rewritten even if a same file is designated and the data rewriting is carried out. In this case, it may be such an implementation that the material file is not stored in the storage section 34, but only stored in the DRAM 32 or an implementation that an encryption key is temporarily created and stored in the DRAM 32 by the processor 31 when the material file is received in ACT 004, and the data encrypted by using the encryption key is stored in the storage section 34. When displaying the data, the encryption key is used to restore the encrypted data, and then the restored data is displayed. When erasing the data, the encryption key in the DRAM 32 is erased and then a deleting command is issued. In this way, it can make the material file left in the storage section 34 meaningless data string.

Return to the determination in ACT 005. If the interruption of the network is not detected (NO in ACT 005), the processor 31 determines whether or not the conference is ended (ACT 010). The determination in ACT 010 is carried out by determining, for example, whether or not a pre-defined gesture is carried out on the touch panel display 36 by the user. If the conference is not ended (NO in ACT 010), the flow returns to ACT 005. On the other hand, if the conference is ended (YES in ACT 010), the processor 31 carries out a logout processing (ACT 011). The logout processing is a processing of sending a logout message to the desktop type information processing apparatus 100. After the logout processing, the processor 31 carries out the data erasing mentioned above (ACT 009)

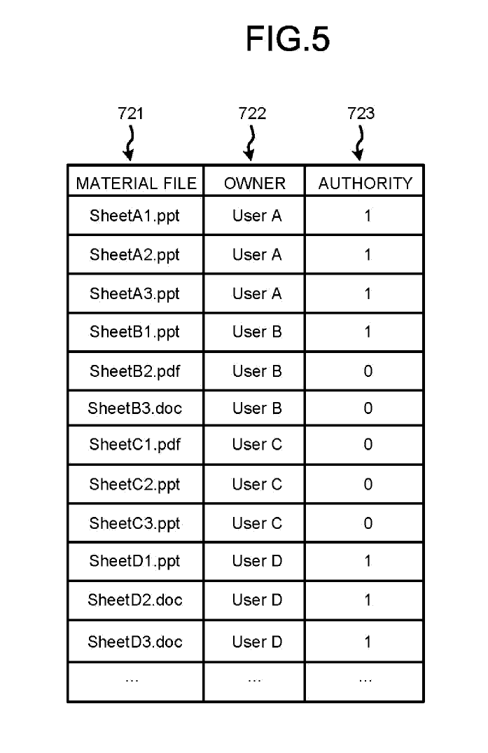

In addition to the flowchart illustrated in FIG. 4, it may also be such an implementation that does not delete the material file in a case where the user himself is a file holder (owner) who created the material file by himself or in a case where the material files created by other users are distributed to the user. FIG. 5 illustrates an example of a data table stored in the tablet PC 302 in this case. In the data table shown in FIG. 5, material file 721 and owner 722 are data set and defined by the desktop type information processing apparatus 100 before the conference is started. Authority 723 is data set according to the progress of the conference. The processor 31 of the tablet PC 302 stores these data in association with each other in the DRAM 32 or the storage section 34.

The names of the files to be used in the conference are stored in the material file 721. The identification information of the user serving as the owner of the material file is stored in the owner 722. Authority 723 is flag data indicating whether or not the material file is distributed to the user who is using the tablet PC 302. A value ‘1’ indicates that the material file is distributed to the user, and a value ‘0’ indicates that the material file is not distributed to the user.

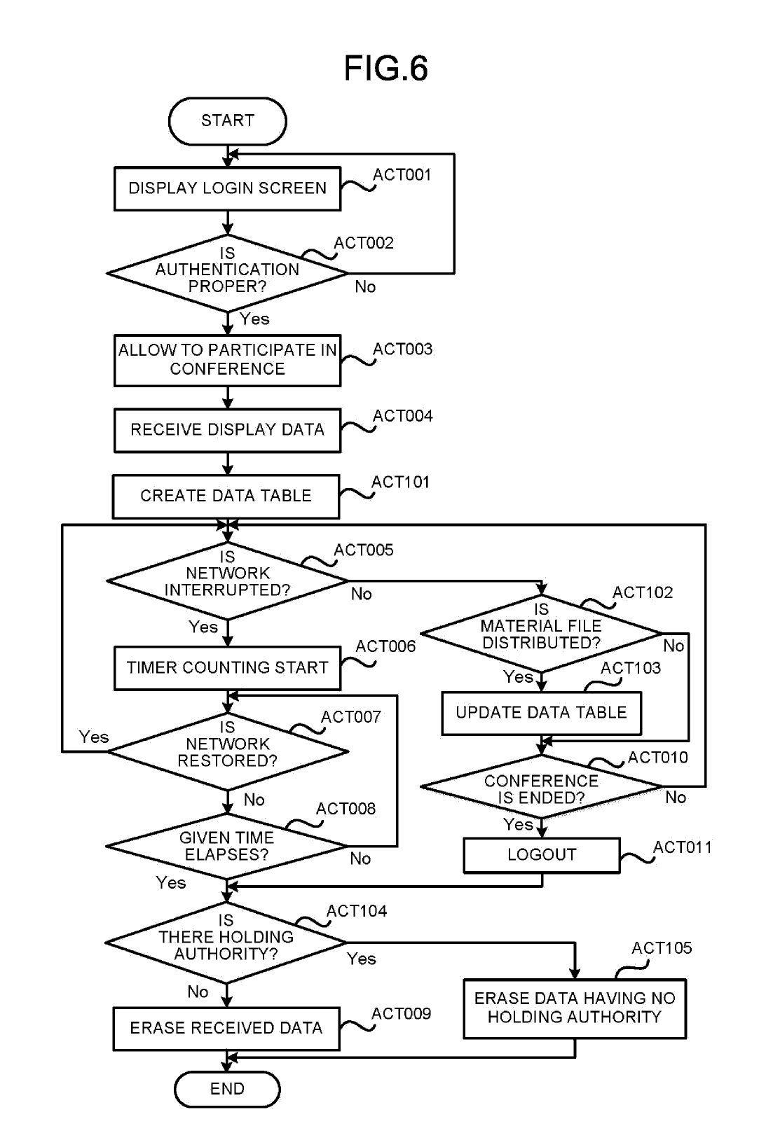

FIG. 6 is a flowchart illustrating the operations of the tablet PC 302 to which the operation taking the holding authority of the file into consideration and controlling to or not to carry out the erasing processing according to the existence/absence of the holding authority is applied. In addition, the holding authority refers to a right to hold the material file. A user of the tablet PC 302 has the holding authority in a case where the user is the owner of the material file or a distribution target.

The processing from ACT 001 to ACT 004 is the same with the flowchart shown in FIG. 4. If the display data is received (ACT 004), the processor 31 creates the data table exemplified in FIG. 5 (ACT 101). Each data value of the material file 721 and the owner 722 is set to be the data received in ACT 004. As to the authority 723, an initial value ‘0’ is set in this stage, and if the user himself is an owner of the material file, a value ‘1’ may also be set.

After the data table is created, a loop processing is carried out until the network is disconnected (YES in ACT 005), or a gesture of ending the conference is received (YES in ACT 010), and the processor 31 determines whether or not the material file is distributed in the loop (ACT 102). As stated with reference to FIG. 3, in a case where an operation of touching the own area 74 and releasing it in the list area 75 or an operation of touching the own area 74 and releasing it in the sharing icon 61 is carried out on any device, the desktop type information processing apparatus 100 sends the name of the corresponding material file to the terminal device (herein, referring to the tablet PC 302) being used by the user serving as the distribution target. Further, by means of the login authentication in ACT 002, it can be known that which user logged in using which information terminal apparatus. Therefore, as the association of the user with the information terminal apparatus used by the user is also completed in ACT 002, the user using the tablet PC 302 can be specified in this stage. The processor 31 of the tablet PC 302 determines whether or not the name of the distributed material file is received from the desktop type information processing apparatus 100 in ACT 102.

If the material file name is received through the network I/F 35 (YES in ACT 102), the processor 31 of the tablet PC 302 rewrites the authority 723 corresponding to the material file name from ‘0’ to ‘1’ (ACT 103), and then the flow proceeds to ACT 010.

In a case of executing the logout processing (ACT 011), or in a case where the network is not restored after being disconnected and a given time elapses (YES in ACT 008), the processor 31 determines the existence/absence of the holding authority (ACT 104). The processor 31 determines, for each material file, whether or not the user himself is an owner, or whether or not the value of the authority 723 is ‘1’ with reference to the data table shown in FIG. 5. In a case where the user himself is the owner of the material file, or the value of the authority 723 corresponding to the material file is ‘1’ (YES in ACT 104), the processor 31 erases other material files having no holding authority, without erasing the material file meeting the condition mentioned above (ACT 105). The erasing method is the same as the processing illustrated in FIG. 4. On the other hand, if no file has the holding authority (NO in ACT 104), all the material files received in ACT 004 are deleted as stated in the flowchart in FIG. 4 (ACT 009).

The conference includes a meeting or a presentation.

In the present embodiment, the function of implementing the invention is pre-recorded in the apparatus. However, the present invention is not limited to this, same function may be downloaded to the apparatus from a network. Alternatively, same function recorded in a recording medium may be installed in the apparatus. The form of the recording medium is not limited as long as the recording medium can store programs like a CD-ROM and the like and is readable by an apparatus. Further, the function realized by an installed or downloaded program can also be achieved through the cooperation with an OS (Operating System) installed in the apparatus.

In accordance with the present embodiment, the conference data can be prevented from being divulged.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An information terminal apparatus, comprising:
a storage section configured to store data to be used in a conference;
a network interface configured to carry out data communication during the conference; and
a control section configured to erase, if the communication through the network interface is interrupted, the data stored in the storage section to be used in the conference.

2. The information terminal apparatus according to claim 1, further comprising:
a display section configured to display the data stored in the storage section; wherein
the control section erases, if the communication through the network interface is interrupted, the image of the data displayed on the display section.

3. The information terminal apparatus according to claim 1, wherein
the control section erases the data stored in the storage section to be used in the conference if the communication through the network interface is interrupted and a given time elapses.

4. The information terminal apparatus according to claim 1, wherein
the network interface carries out data communication with an access point having a leaky coaxial cable during the conference.

5. The information terminal apparatus according to claim 1, wherein
the control section does not erase the data stored in the storage section if the data is allowed to be held by a user using the information terminal apparatus.

6. The information terminal apparatus according to claim 1, wherein
the control section does not erase the data stored in the storage section if the data is created by a user using the information terminal apparatus.

7. The information terminal apparatus according to claim 1, wherein
the control section erases the data stored in the storage section to be used in the conference if an operation for logging off from the conference system is received from a user.

8. A conference system, comprising:
a server apparatus;
an access point configured to include a leaky coaxial cable; and
an information terminal apparatus configured to carry out data communication with the server apparatus through the access point, and erases the data stored in its own storage section to be used in the conference if the communication is interrupted.

9. The conference system according to claim 8, wherein
the information terminal apparatus displays the data stored in the storage section, and erases the image of the displayed data if the communication is interrupted.

10. The conference system according to claim 8, wherein
the information terminal apparatus erases the data stored in the storage section to be used in the conference if the communication through the network interface is interrupted and a given time elapses.
